(19) United States
(12) Patent Application Publication
(10) Pub. No.: US 2026/0094532 A1
(43) Pub. Date: Apr. 2, 2026

(54) LEARNING GUIDANCE DEVICE, AND METHOD AND COMPUTER PROGRAM FOR REMOTELY MONITORING LEARNER'S LEARNING SITUATION

(71) Applicant: JEI E-ACADEMY, Seoul (KR)

(72) Inventors: Sunghoon PARK, Seoul (KR); Jongwoo PARK, Seoul (KR); Gyutae BAEK, Seoul (KR); Sungjae HAN, Seoul (KR)

(73) Assignee: JEI E-ACADEMY, Seoul (KR)

(21) Appl. No.: 19/120,213

(22) PCT Filed: Oct. 12, 2023
(86) PCT No.: PCT/KR2023/015763

§ 371 Date: Apr. 10, 2025

(30) Foreign Application Priority Data
Oct. 14, 2022 (KR) 10-2022-0132733

(51) Int. Cl. G09B 5/14; G06F 3/16; G06V 20/52; G06V 40/10; G06V 40/20; H04L 65/1069

(52) U.S. Cl. CPC G09B 5/14; G06F 3/167; G06V 20/52; G06V 40/10; G06V 40/28; H04L 65/1069

(57) ABSTRACT

According to embodiments of the present disclosure, there is provided a method of remotely monitoring a learner's learning situation, the method including: by a learning guidance device, obtaining first image data generated by capturing an image of a learner through a first camera, and obtaining second image data generated by capturing an image of a learning paper through a second camera; obtaining, by the learning guidance device, a voice command of the learner through the first or second camera; transmitting, by the learning guidance device, a signal for requesting guidance data comprising the first or second image data, corresponding to the voice command of the learner, to a learning management server; and outputting, by the learning guidance device, the guidance data received from the learning management server.

### TECHNICAL FIELD

Embodiments of the present disclosure relate to a learning guidance device and a method and computer program for remotely monitoring a learner's learning situation.

### BACKGROUND ART

In early 2000s, e-learning represented by Internet lectures emerged, but developments in EdTech industries using virtual reality (VR), artificial intelligence (AI), etc. have been slow. Due to the outbreak and spread of COVID-19, for the first time in history, online classes began in public education, and this brought the formation of social empathy for the need to facilitate the EdTech industries. In one-way online education, there has been a general trend towards 1:n communication methods whereby content is viewed, remote discussions, or education methods using one-to-one video calls.

Thus, there has emerged the need for a learning device which may enable smooth guidance at a point at which active guidance is required in a learner's studying situation.

### DISCLOSURE OF INVENTION

### Technical Problem

Embodiments disclosed in the present specification aim to provide a learning guidance device and a method and computer program for remotely monitoring a learner's learning situation.

Also, embodiments disclosed in the present specification aim to monitor, by recognizing a learner or a learning paper, whether or not learning is started.

Also, embodiments disclosed in the present specification aim to provide guidance data corresponding to a voice command, when the voice command requesting a guidance is detected from a learner's voice.

Also, embodiments disclosed in the present specification aim to output, when an interruption element is recognized during a learning situation, a warning message in response to this, so that a learner may keep learning.

Also, embodiments disclosed in the present specification aim to obtain data with respect to a learning progression situation by capturing an image of a learning paper which is a learning area.

### Solution to Problem

According to an embodiment of the present disclosure, there is provided a method of remotely monitoring a learner's learning situation, the method including: by a learning guidance device, obtaining first image data generated by capturing an image of a learner through a first camera, and obtaining second image data generated by capturing an image of a learning paper through a second camera; obtaining, by the learning guidance device, a voice command of the learner through the first or second camera; transmitting, by the learning guidance device, a signal for requesting guidance data including the first or second image data, corresponding to the voice command of the learner, to a learning management server; and outputting, by the learning guidance device, the guidance data received from the learning management server.

According to embodiments of the present disclosure, there is provided the method of remotely monitoring the learner's learning situation, the method further including determining, by the learning guidance device, whether or not the learner appears and whether or not the learning paper is open, by analyzing the first or second image data by using one or more situation recognition models, and when whether or not the learner appears is true and whether or not the learning paper is open is true, setting, by the learning guidance device, a learning situation as “performing learning.”

According to embodiments of the present disclosure, there is provided the method of remotely monitoring the learner's learning situation, the method further including detecting, by the learning guidance device, a hand area and a writing instrument area from the second image data, and, based on whether or not the hand area and the writing instrument area are in contact with each other, setting, by the learning guidance device, a learning situation as “maintenance of learning.”

According to embodiments of the present disclosure, there is provided the method of remotely monitoring the learner's learning situation, the method further including calculating, by the learning guidance device, a finger end point or a writing instrument end point from the second image data, and setting, by the learning guidance device, the finger end point or the writing instrument end point as a pointing point.

According to embodiments of the present disclosure, there is provided the method of remotely monitoring the learner's learning situation, the method further including connecting, by the learning management server, a video call between the learning guidance device and an instructor terminal device of an instructor in charge of the learner.

A computer program according to an embodiment of the present disclosure may be stored on a medium for executing, by using a computer, any one of the methods according to an embodiment of the present disclosure.

In addition, there is further provided a computer-readable recording medium having recorded thereon a computer program for executing another method and another system for realizing the present disclosure and the method.

Other aspects, features, and advantageous in addition to the descriptions above may become apparent from the drawings, claims, and detailed descriptions of the invention hereinafter.

### Advantageous Effects of Invention

According to any one of the solutions to problems described above, a learning guidance device and a method and computer program for remotely monitoring a learner's learning situation may be provided.

Also, data may be generated by monitoring whether or not learning is started by recognizing a learner or a learning paper.

Also, when a voice command requesting a guidance is detected in a learner's voice, guidance data corresponding to the voice command may be provided.

Also, when an interruption element is recognized in a learning situation, in response to this, a warning message may be output for a learner to keep learning.

Also, data with respect to a learning progression situation may be obtained by capturing an image of a learning paper which is a learning area.

### BRIEF DESCRIPTION OF DRAWINGS

FIG. 1 is a view for describing a use form of a learning guidance device according to embodiments of the present disclosure.

FIG. 2 is a view with respect to a network environment according to embodiments of the present disclosure.

FIG. 3 is a block diagram of a learning guidance device according to embodiments of the present disclosure.

FIG. 4 is a block diagram of a learning management server 200 according to embodiments of the present disclosure.

FIG. 5 is a block diagram of an instructor terminal device 300 according to embodiments of the present disclosure.

FIG. 6 is a flowchart of a learning instruction method according to embodiments of the present disclosure.

FIG. 7 is a flowchart of a process of processing guidance data, according to embodiments of the present disclosure.

FIG. 8 is an example view of a situation in which whether or not a learner appears is false.

FIG. 9 is an example view of a situation in which whether or not a learning object interruption element is recognized is true.

FIG. 10 is an example view of another situation in which whether or not a learning object interruption element is recognized is true.

### BEST MODE FOR CARRYING OUT THE INVENTION

Hereinafter, the structures and operations of the present disclosure will be described in detail with reference to embodiments of the present disclosure illustrated in the accompanying drawings.

Various modifications may be made to the present disclosure, and the present disclosure may have various embodiments, and thus, certain embodiments are shown by way of example in the drawings and will herein be described in detail. The effects and the characteristics of the present disclosure, and methods of realizing the same will become apparent by referring to the drawings and embodiments described in detail below. However, the present disclosure is not limited to the embodiments disclosed below and may be realized in various forms.

Hereinafter, embodiments of the present disclosure will be described in detail by referring to the accompanying drawings. In descriptions with reference to the drawings, the same reference numerals are given to elements that are the same or substantially the same and descriptions will not be repeated.

In this specification, the terms “learn,” “learning,” etc. are not intended to refer to a psychological operation, such as a human's educational activity, but shall be interpreted as referring to the performance of machine learning through computing according to a procedure.

In embodiments hereinafter, terms such as first, second, etc. are used to distinguish one element from another, rather than being used to define meanings.

In embodiments hereinafter, the singular expressions are intended to include the plural forms as well, unless the context clearly indicates otherwise.

In embodiments hereinafter, terms such as comprises and/or comprising specify the presence of features or components stated in the specification, and do not preclude the probable addition of one or more other features or components.

In the drawings, sizes of elements may be exaggerated or reduced for convenience of explanation. For example, the size and thickness of each element in the drawings are randomly indicated for convenience of explanation, and thus, the present disclosure is not necessarily limited to the illustrations of the drawings.

When a certain embodiment may be implemented differently, a specific process order may be performed differently from the described order. For example, two consecutively described processes may be performed substantially at the same time or performed in an order opposite to the described order.

In the present specification, “provision” may include at least one of visual outputting and audible outputting.

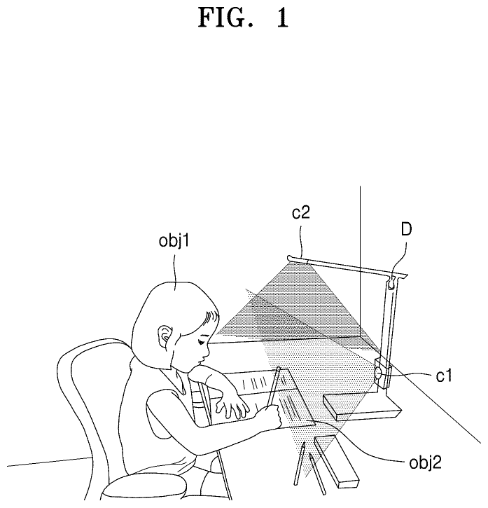

FIG. 1 is a view for describing a use form of a learning guidance device according to embodiments of the present disclosure.

As illustrated in FIG. 1, a learning guidance device D according to an embodiment of the present disclosure may be realized as a portion of a desk lamp device.

The learning guidance device D refers to a device for providing a smooth learning environment to a learner having difficulty managing face-to-face lessons.

The learning guidance device D refers to a device equipped with at least two cameras c1 and c2. The learning guidance device may include one camera c1 configured to capture an image of a learner obj1 and one camera c2 configured to capture an image of a learning area obj2. The learning guidance device D may be connected to an external camera and may receive data generated by capturing an image of the learner obj1 or the learning area obj2.

The learning guidance device D may recognize a learner and detect the learner through the camera c1 configured to capture an image of the learner and may use the detected information to track a situation of the learner.

The learning guidance device D may recognize a learning area through the camera c2 configured to capture an image of the learning area and may track an object in the learning area.

The learning guidance device D may obtain information with respect to the learner, based on the data obtained through the cameras c1 and c2.

A learner wishing to receive a learning guidance through the learning guidance device D may control an area recognized by the cameras c1 and c2 of the learning guidance device D to be oriented toward the learner and/or a learning area. The cameras c1 and c2 may be attached to the learning guidance device D through an element capable of switching directions. The learning guidance device D may provide an indication, such as a warning sound, warning light, etc., while the learner obj1 and/or the learning area abj2 are/is not being recognized. The learning guidance device D may not perform an operation until a learner and a learning area are recognized.

The learning guidance device D may provide an indication for a rest, when a learning time equal to or greater than a predefined maximum learning time is detected. The learning guidance device D may display information about completion of learning, when it is determined through a detected learning area that learning is completed.

The learning guidance device D may provide guidance data generated by its own logic, in response to a detection of a sudden situation occurring with respect to a learner or a learning area. The detection of the sudden situation may be performed by using a model trained through data (an image, a parameter, etc.) generated by capturing an image of the learner or the learning area. However, it is not limited thereto, and an object detection and identification algorithm may be used. The trained model may be trained through data generated by capturing an image of a corresponding learner or data generated by capturing an image of another learner. The trained model may be designed to operate on its own even in a situation in which there is no communication connected. The learning guidance device D may provide communication with an instructor in response to the detection of the sudden situation occurring with respect to the learner or the learning area. The learning guidance device D may provide guidance data of the instructor through a terminal of the instructor. Here, the sudden situation may include inquiry about learning content, one-to-one coaching about the learning content, an emergence of a learning interruption element, a sudden exit of the learner, etc.

The learning guidance device D may operate through communication with a server device through a network and may operate by using an embedded algorithm.

The learning guidance device D may communicate with the terminal of the instructor directly or through a server. The learning guidance device D may communicate with the terminal of the instructor nearby through a communication method, such as Bluetooth, WiFi, infrared rays, Zigbee, etc., and may transmit and receive data to and from the terminal of the instructor.

The learning guidance device D may track the learner and/or the learning area to help the learner come into a learning completion situation. The learning guidance device D may track a learning process from the start to a finish of learning and may provide guidance data with respect to the learner or the learning area.

The learning guidance device D may be realized in combination with an illumination device. However, it is only an embodiment. The two cameras may be realized as separate cameras.

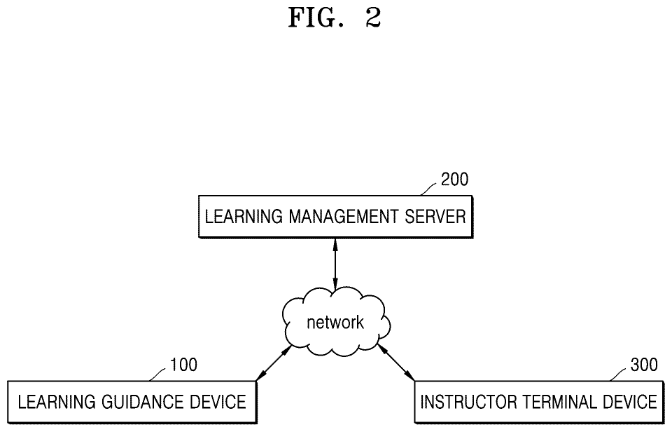

FIG. 2 is a view with respect to a network environment according to embodiments of the present disclosure.

A learning guidance system according to embodiments of the present disclosure may include a learning guidance device 100, a learning management server 200, and an instructor terminal device 300.

The learning guidance device 100 may obtain data with respect to a learner and/or a learning area and may infer a situation of the learner, a learning process, and a learning state by analyzing the data with respect to the learner and/or the learning area. The learning guidance device 100 may infer the situation of the learner, the learning process, and the learning state by using a neural network for inferring a situation of a learner, a neural network for inferring a learning process, a neural network for inferring a learning situation, etc. The learning guidance device 100 may generate and provide learning guidance data corresponding to the situation of the learner and/or the data, such as the learning process, the learning state, etc. The learning guidance data may be received from the learning management server 200 or may be generated by processing data received from the learning management server 200. The learning guidance data may be received from the instructor terminal device 300 or may be generated by processing data received from the instructor terminal device 300.

The learning management server 200 may perform a function of training machine learning models for inferring the situation of the learner, the learning process, and the learning state. The learning management server 200 may train the machine learning models for inferring the situation of the learner, the learning process, and the learning state, by using, as training data, data obtained through a plurality of learning guidance devices and an output value respect to the data.

The model for inferring the situation of the learner may be trained by using data generated by capturing an image of the learner and training data with respect to the situation of the learner (whether or not the learner is learning, whether or not the learner is concentrated, whether or not the learner is making progression in learning, etc.). The model for inferring the situation of the learner may be designed to output the situation of the learner by using, as an input, the captured image data. The model for inferring the situation of the learner may be trained by various methods, such as machine learning, non-supervised learning, reinforcement learning, etc. The model for inferring the situation of the learner may be trained by using the data input through the learning guidance devices of a plurality of learners. Here, whether or not the learner is concentrated may be determined based on a learning speed. As a learning time of one page decreases, it may be recorded as a higher concentration state. Here, a comparison with respect to the learning time may be performed as a comparison with the average learning time of a corresponding learner.

The model for inferring the learning process may be trained by training data for outputting the learning process by using, as inputs, the data generated by capturing an image of the learner and the data generated by capturing an image of a learning paper. The model for inferring the learning process may be designed to output the learning process by using, as an input, the data generated by capturing an image of the learner and the data generated by capturing an image of the learning paper. The learning process may include a future learning progression quantity according to a sequential flow of learning. At the end point of learning, data with respect to the output learning process may be output, to increase the learning motivation of the learner. The model for inferring the learning process may be trained by various methods, such as machine learning, non-supervised learning, reinforcement learning, etc. The model for inferring the leaning process may be trained by using data that is input through learning guidance devices of a plurality of learners. The model for inferring the learning process may be trained by grouping (categorizing, clustering, etc.) data with respect to learners having a similar pattern.

The model for inferring the learning situation may be trained by data generated by capturing an image of the learner, data generated by capturing an image of the learning paper, and training data with respect to the learning situation (whether or not learning is performed, whether or not learning is continued, whether or not learning is finished, learning coaching, learning inquiry, etc.). The model for inferring the learning situation may be designed to output the learning situation (whether or not learning is performed, whether or not learning is continued, whether or not learning is finished, learning coaching, learning inquiry, etc.) by using, as an input, the data generated by capturing an image of the learner and the data generated by capturing an image of the learning paper. The model for inferring the learning situation may be trained by various methods, such as machine learning, non-supervised learning, reinforcement learning, etc. The model for inferring the learning situation may be trained by using data that is input through learning guidance devices of a plurality of learners. The model for inferring the learning situation may be trained by grouping (categorizing, clustering, etc.) data with respect to learners having a similar pattern.

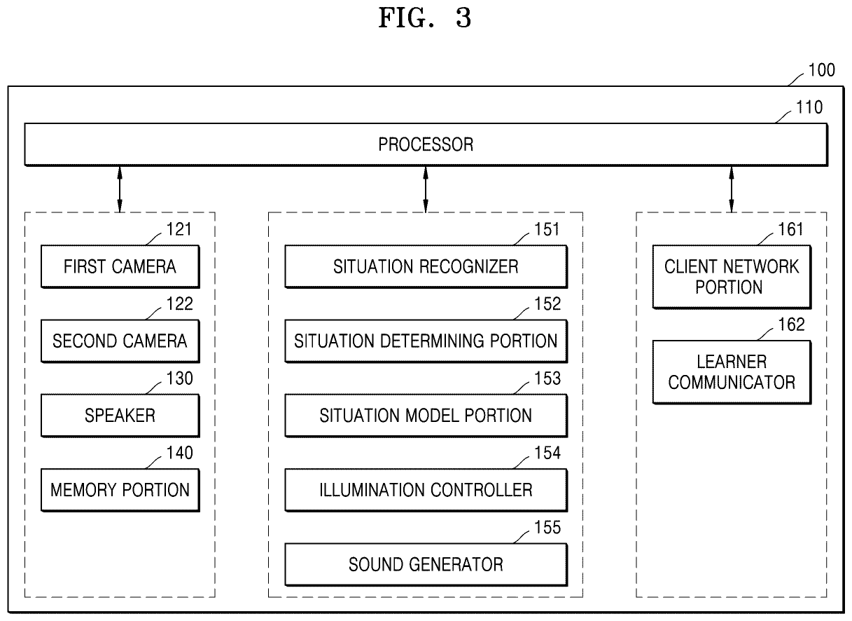

FIG. 3 is a block diagram of a learning guidance device.

The learning guidance device may include a processor 110, a first camera 121, a second camera 122, a speaker 130, a memory portion 140, a situation recognizer 151, a situation determining portion 152, a situation model portion 153, an illumination controller 154, a sound generator 155, a client network portion 161, and a learner communicator 162.

The processor 110 may control general operations of the learning guidance device 100 in general. For example, the processor 110 may generally control the components included in the learning guidance device 100 by executing a program stored in the learning guidance device 100, the situation recognizer 151, the situation determining portion 152, the situation model portion 153, the illumination controller 154, the sound generator 155, the client network portion 161, the learner communicator 162, etc.

The processor 110 may be realized as a digital signal processor (DSP) configured to process a digital signal, a microprocessor, or a time controller (TCON). However, it is not limited thereto and may include, or may be defined by, one or more from among a central processing unit (CPU), a micro controller unit (MCU), a micro processing unit (MPU), a controller, an application processor (AP), a communication processor (CP), and an advanced reduced-instruction-set-computer (RISC) machine (ARM) processor. Also, the processor 110 may be realized as a system on chip (SoC), large scale integration (LSI), or a field programmable gate array (FPGA), in which processing algorithms are embedded.

The first camera 121 may be realized to capture an image of an area in which a learner is present. The first camera 121 may be mounted at a predefined position and may capture the image, and may be realized to capture the image by adjusting a distance and controlling focusing according to a position of the learner, etc. When a learner hears a message about a case where whether or not the learner appears is false, the learner may give an input of changing the position and setting of the first camera. Whether or not the learner appears may be determined based on the data generated by capturing an image through the first camera 121.

The second camera 122 may be realized to capture an image of an area in which a learning paper exists. The second camera 122 may be mounted at a predefined position and may capture the image, and may be realized to capture the image by adjusting a distance and controlling focusing according to a position of the learner, etc. At least one of whether or not the learning paper is open and whether or not a learning object interruption element is recognized may be determined based on the data generated by capturing an image through the second camera 122.

The speaker 130 may output audible data. The audible data to be provided to the learner may be output. The speaker 130 may output the audible data received from at least one of the situation recognizer 151, the situation determining portion 152, the client network portion 161, and the learner communicator 162.

The memory portion 140 may store data obtained directly by the learning guidance device 100. The memory portion 140 may store data about a process to be processed, according to a learning situation. The memory portion 140 may store a learner attribute vector for identifying a learner. The memory portion 140 may store a blocking entity for recognizing a learning object interruption element. The memory portion 140 may store data with respect to a voice command to be processed. The data with respect to the voice command may be limited to data with respect to each learner. The memory portion 140 may store data with respect to a learning situation, about which determination is to be made by using obtained data.

The situation recognizer 151 may infer the state of the learner and the situation of learning by analyzing input image data and/or sound data.

The situation recognizer 151 may receive first image data obtained through the first camera 121 and first sound data and may derive a facial area from the first image data by using a neural network. The situation recognizer 151 may detect a feature point of a face from an image of the recognized facial area. The situation recognizer 151 may normalize the facial area as a constant shape and size and may distinguish/identify whether or not the facial area corresponds to a real user by comparing the normalized facial area with the learner attribute vector stored in the memory portion with respect to a degree of similarity. The situation recognizer 151 may determine whether or not the learner appears, through the process described above.

When there is no pre-stored learner attribute vector, a recognized feature of the learner may be stored as the learner attribute vector. There may be one or more learners. The learner attribute vector may be separately registered for each learner.

The situation determining portion 152 may periodically determine whether or not an identified learner is continually present in a nearby position. The situation determining portion 152 may periodically identify whether or not the learner is present, by using a histogram-based object tracing method. The situation determining portion 152 may determine whether or not the learner is away from a learning spot, the degree of concentration of the learner, etc. The situation determining portion 152 may periodically determine a position of an object recognized as the learner and may calculate whether or not the learner is away from the learning position. The situation determining portion 152 may calculate the degree of concentration of the learner by gathering data, such as a position of the face, a position of the hand, and the eyes of the learner, etc. By using pre-stored data of a behavioral pattern of the learner, the degree of concentration of the learner according to the data, such as the position of the face, the position of the hand, and the eyes of the learner, etc., may be calculated.

The situation recognizer 151 may perform the estimation of a document area from the image data captured through the second camera by using a neural network. The algorithm for extracting the document area may include an outline detection algorithm. In more detail, the situation recognizer 151 may receive the image data including a document and may pre-process the image data by using a neural network-based edge detection model. The situation recognizer 151 may extract the largest external outline in an image and may perform distance transition based on the largest external outline. The situation recognizer 151 may detect a square-shaped outline connecting four vertexes as a candidate of the document area.

The situation recognizer 151 may extract a printed area from the image data by using document dewarping. The printed area may be generally extracted. The situation recognizer 151 may separately extract each of a letter, an image, etc. included in the printed area. The situation recognizer 151 may extract a feature point from the extracted printed area through image pattern matching. The situation recognizer 151 may determine whether or not the learning paper is open, by using text, image, etc. of the printed area.

The situation recognizer 151 may recognize a text page number in the extracted printed area by using OCR, a position of the page number, or a pattern of the page number.

The situation determining portion 152 may identify the learning amount and the learning situation by using the learning area and the text page number. For example, when the learner starts learning from page 5 and finishes learning at page 7, the learning amount of the learner corresponding to the date may be recorded as 2 pages, and the learning situation may be recorded as completion to page 7.

The situation determining portion 152 may calculate a learning speed, by using the learning area and the text page number. For example, time taken to move from the text page number 1 to the text page number 2, time taken to move from the text page number 2 to the text page number 3, etc. may be periodically measured, and the learning speed may be calculated by using the average value of the times.

The situation determining portion 152 may directly perform, on the user terminal level, the estimation of the document area by using a neural network.

The situation recognizer 151 may recognize a hand area and/or a writing instrument area by analyzing the image data captured by the second camera. The situation recognizer 151 may extract coordinates of an end point of a finger and an end point of a writing instrument in the hand area and may determine, based on whether or not the coordinates of the end point of the finger and the end point of the writing instrument correspond to each other, whether or not the finger touches the writing instrument. The end point of the finger may include an end point of each of fingers recognized in the hand area. The end point of the writing instrument may include an end point in the writing instrument area. Whether or not the coordinate of the end point of the finger corresponds to the coordinate of the end point of the writing instrument may be determined based on whether or not a distance value between the coordinate of the end point of the finger and the coordinate of the end point of the writing instrument is within a preset minimum distance value.

The situation recognizer 151 may analyze the image data captured by the second camera and may determine whether or not there is, on a desk, an element for causing interruption for concentration of learning The situation recognizer 151 may detect an object existing in the learning area or an area except for the learning area in the image data captured by the second camera. An object may be identified in an area of the detected object. When the identified object is determined not to be present in a previous learning space, it may be determined that there is the element for causing interruption for the concentration of learning. For example, when the identified object includes a cellular phone, a game machine, a toy, etc., it may be determined that there is the element for causing interruption for the concentration of learning. When a voice of a human, a sound, etc. except for the hand of a human or the learner are detected, it may be determined that there is the element for causing interruption for the concentration of learning. Whether or not there is the element for causing interruption for the concentration of learning may be determined through a module trained through image data captured for each learner. When the degree of concentration of the learner decreases and a new object is detected through pieces of previously captured image data, it may be determined that there is the element for causing interruption for the concentration of learning, The situation recognizer 151 may determine whether or not there is, on the desk, the element for causing interruption for the concentration of learning, by comparing an entity derived through object recognition from the image data captured by the second camera with the blocking entity stored in the memory portion. Through the process described above, the situation recognizer 151 may determine whether or not a learning object interruption element is recognized.

The situation recognizer 151 may detect an area pointed by the learner, by analyzing the image data captured by the second camera. When it is detected through a hand area and a writing instrument area that a hand and a writing instrument are in contact with each other, the situation recognizer 151 may extract a coordinate at which the hand and the writing instrument are in contact with each other as the area pointed by the learner. When it is detected that the hand and the writing instrument are not in contact with each other, the situation recognizer 151 may detect a coordinate of an end point of an index finger as the area pointed by the learner. By using the area pointed by the learner, the situation recognizer 151 may determine whether or not a learning paper object is pointed. Whether or not the learning paper object is pointed may be determined in a predefined situation, for example, where there is a certain voice event, touch event, or gesture event.

Additionally, the situation recognizer 151 may determine, through the first and second cameras, whether or not a reserved voice command is input. When sound data corresponding to a pre-stored voice command is input, information according to the voice command may be recognized.

The situation determining portion 152 may identify the learning situation by summarizing at least one of the pieces of information determined by the situation recognizer 151, such as whether or not the learner appears, whether or not the learning paper is open, whether or not the learning paper object is pointed, whether or not the learning object interruption element is recognized, and whether or not the reserved voice command is input. The learning situation may correspond to any one of learning execution, maintenance of learning, finishing learning, learning inquiry, and learning coaching.

Learning execution refers to a situation in which both of the learner and the learning paper are recognized through the camera. Learning execution may correspond to a state of the case where the learner is detected in data generated by capturing an image through the first camera and the learning paper is detected in data generated by capturing an image through the second camera. Maintenance of learning refers to a state in which learning is continued without learning obstacles after learning is executed. Maintenance of learning may correspond to a state of the case where whether or not the learning paper is open is true, whether or not the learning paper object is pointed is false, whether or not the learning object interruption element is recognized is false, and whether or not the voice command is input is false. Finishing learning refers to a state in which the learner or the learning paper become out of the camera while learning is being kept. It may correspond to a state of the case where the learner is not detected in the data generated by capturing the image through the first camera or the learning paper is not detected in the data generated by capturing the image through the second camera. Learning inquiry refers to a state in which the learner requests assistance through a reserved instruction while learning is being kept. Learning inquiry may correspond to a state of the case where whether or not the voice command is input is true. Learning coaching refers to a state in which learning guidance is performed according to a request or a situation of the learner.

When a voice command of the learner is input, the situation determining portion 152 may determine whether or not the voice command of the learner corresponds to a preset command, and when the voice command of the learner is a pre-stored inquiry command, the situation determining portion 152 may generate information about a learning paper area, the image of which is captured by the second camera. The information about the learning paper area may include a page number of the learning paper, whether or not a learning paper object is pointed in the learning paper, a pointing point (coordinate information), etc. Data about the voice command may include text corresponding to the voice command, sound data of the voice command, etc. The situation determining portion 152 may transmit the data about the voice command of the learner and the information about the learning paper area to the learning management server 200 and may request guidance data according to the data about the voice command of the learner and the information about the learning paper area. The situation determining portion 152 may generate a signal for requesting guidance data including inquiry content and an inquiry object. The inquiry content may be extracted from the data about the voice command. The inquiry object may be related to a question area and may be extracted from the information about the learning paper area. When there is a pointing point in the learning paper area, the inquiry object may include an area of the pointing point, and when there is no pointing point in the learning paper area, the inquiry object may include an area of the page number.

The situation determining portion 152 may infer the learning situation by using a model for inferring a situation of a learner, a model for inferring a learning process, a model for inferring a learning situation, etc.

The learning management server 200 may transmit the received signal for requesting the guidance data to the instructor terminal device 300. The learning management server 200 may determine an instructor according to the inquiry content and the inquiry object included in the guidance data and may transmit the guidance request signal to the instructor terminal device 300. The learning management server 200 may determine the instructor as an instructor in charge of the learner, but may determine the instructor as another instructor when the instructor in charge of the learner is supervising learning. The learning management server 200 may transmit the guidance request signal to terminal devices of instructors and may determine an instructor firstly responding to the guidance request signal as the instructor with respect to the corresponding inquiry. The guidance request signal may correspond to the data with respect to the voice command and the data (captured image data) with respect to the learning paper area.

After the instructor is determined, a voice call may be performed between the learner communicator 162 of the learning guidance device 100 and an instructor communicator of the instructor terminal device 300. Here, the voice call may be based on Web real-time communication (RTC)/IP.

In response to the signal for requesting the guidance data, the learning guidance device 100 may generate and provide guidance data corresponding to the signal based on predefined pieces of guidance data.

In a situation in which the instructor may not be determined, the learning management server 200 may transmit and provide a message indicating the situation of no instructor. The message may be provided as a voice.

Examples of the guidance data predefined in the learning guidance device 100 may be as below.

When the learner is recognized through the first camera and the learning paper is not recognized through the second camera, the learning guidance device 100 may output a message for inducing learning. In order to induce learning, the learning guidance device 100 may generate, from the illumination controller 154, an illumination control signal for changing the intensity of illumination and the direction of illumination. When a time value, during which the learning paper is not recognized through the second camera, is counted, and when the corresponding time value is greater than or equal to a pre-stored inducement time value, the message for inducing learning may be output, or the illumination control signal for changing the intensity, the direction, etc. of illumination may be generated from the illumination controller 154.

The learning guidance device 100 may analyze the image data captured by the second camera and may output a warning message when whether or not the learning object interruption element is recognized is true. With respect to the corresponding situation, the learning guidance device 100 may generate a pre-stored illumination control signal from the illumination controller 154. For example, the illumination control signal for expressing types of highlight illumination, such as a red color, etc., in a blinking fashion, may be generated.

When it is recognized that the learning is being continued for a time period greater than or equal to a pre-stored maximum learning time value, the learning guidance device 100 may output a message recommending a rest and may generate the illumination control signal for adjusting the brightness of illumination.

When it is detected that the learner or the learning paper disappears, the learning guidance device 100 may consider learning as finished and may output information, such as the learning duration time, the learning status, the learning speed, the learning progression amount, etc., as a voice. The learning guidance device 100 may generate the illumination control signal for turning off illumination as the learning is ended.

The illumination control signal may include information such as the intensity, color, blinking, direction, etc. of illumination.

The situation model portion 153 may store a neural network model file and may provide the neural network model file requested by the situation recognizer 151. The situation model portion 153 may store and manage the model for inferring the situation of the learner, the model for inferring the learning process, the model for inferring the learning situation, etc. trained by the learning management server 200. The situation model portion 153 may periodically update the model for inferring the situation of the learner, the model for inferring the learning process, the model for inferring the learning situation, etc. trained by the learning management server 200.

The illumination controller 154 may generate the illumination control signal based on input data. The illumination controller 154 may generate the illumination control signal according to a signal obtained through the situation determining portion 152.

The sound generator 155 may generate audible data, etc. according to the signal obtained through the situation determining portion 152 and may output the audible data.

The client network portion 161 may transmit and receive data by communicating with the learning management server 200.

The learner communicator 162 may communicate with the instructor communicator and may enable execution of the voice call.

The learning guidance device 100 may transmit, to the learning management server 200, data inferred through the model for inferring the situation of the learner, the model for inferring the learning process, the model for inferring the learning situation, etc. The learning management server 200 may use the received data, with respect to a learning progress of the learner, the determination of the instructor, and the learning guidance. For example, when the learning is performed for three or more hours a day, a schedule for distributing the learning time less than or equal to three hours may be provided to a learner having decreasing concentration and a schedule for studying one subject a day may be provided to a learner exerting high concentration throughout a day. Also, guidance data, rather than one-to-one coaching, may be automatically generated and provided to a type of learner solving problems with a simple learning guidance. Learning coaching may be enabled by connecting a video call with the instructor for a type of learner improving understanding through communication with the instructor.

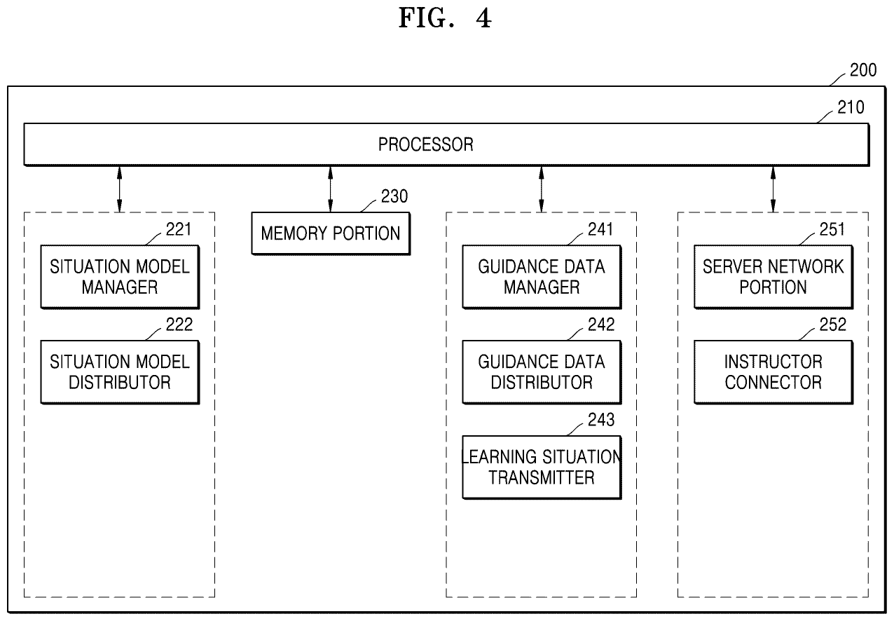

FIG. 4 is a block diagram of the learning management server 200 according to embodiments of the present disclosure.

The learning management server 200 may include a processor 210, a situation model manager 221, a situation model distributor 222, a memory portion 230, a guidance data manager 241, a guidance data distributor 242, a learning situation transmitter 243, a server network portion 251, and an instructor connector 252.

The processor 210 may control general operations of the learning management server 200 in general. For example, the processor 210 may generally control the components included in the learning management server 200 by executing a program stored in the learning management device 200, the situation model manager 221, the situation model distributor 222, the memory portion 230, the guidance data manager 241, the guidance data distributor 242, the learning situation transmitter 243, the server network portion 251, the instructor connector 252, etc.

The processor 210 may be realized as a DSP configured to process a digital signal, a microprocessor, or a TCON. However, it is not limited thereto and may include, or may be defined by, one or more from among a CPU, an MCU, an MPU, a controller, an AP, a CP, and an ARM processor. Also, the processor 110 may be realized as an SoC, LSI, or an FPGA, in which processing algorithms are embedded.

The situation model manager 221 may perform generation, updating, etc. of a situation recognition model and a situation determination model which are to be stored in the learning guidance device 100. The situation model manager 221 may generate and provide the situation recognition model and the situation determination model using a neural network appropriate for each of a plurality of learning guidance devices.

The situation model manager 221 may additionally generate a model for inferring a situation of a learner, a model for inferring a learning process, a model for inferring a learning situation, etc.

The situation model distributor 222 may perform distribution of the situation recognition model, the situation determination model, the model for inferring the situation of the learner, the model for inferring the learning process, the model for inferring the learning situation, etc. to be stored in the learning guidance device 100. The procedure of monitoring and updating the situation recognition model, the situation determination model, the model for inferring the situation of the learner, the model for inferring the learning process, the model for inferring the learning situation, etc. distributed to the learning guidance device 100 may be controlled.

The memory portion 230 may store data with respect to registered learning guidance devices, data with respect to a registered instructor terminal device, information about devices at which non-face-to-face guidance is performed, data with respect to instructors currently performing guidance, data with respect to instructors standing by for guidance, data with respect to a situation recognition model and a situation determination model installed on each learning guidance device, etc.

The guidance data manager 241 may generate, delete, and update text data to be used to generate guidance data and the illumination control signal.

The guidance data distributor 242 may generate the guidance data according to a signal for requesting the guidance data received from the learning guidance device 100. The guidance data may be transmitted to the learning guidance device 100 through the server network portion 251.

The guidance data distributor 242 may perform scheduling for updating the guidance data to be provided to the learning guidance device 100.

The learning situation transmitter 243 may periodically receive data about a learning situation from the learning guidance device 100 and may transmit the received data about the learning situation to the terminal device 300 of the instructor. The data about the learning situation may further include a determined learning situation and data generated by determining the learning situation. For example, the learning situation transmitter 243 may transmit, to the instructor terminal device 300, whether or not a learning paper object is pointed and a pointing point, and whether or not a learning object interruption element is recognized and captured image data. When an instructor terminal device has not yet been determined, the learning management server 200 may transmit the data about the learning situation to one or more instructor terminal devices.

The server network portion 251 may be in charge of data transmission and reception by communicating with a client network portion of the learning guidance device 100.

When the instructor connector 252 receives a signal from the learner for requesting non-face-to-face guidance, the instructor connector 252 may notify data included in the signal for requesting the non-face-to-face guidance to an instructor in charge or other instructors standing by and may connect communication with an instructor responding.

The learning management server 200 may additionally request evaluation data with respect to the instructor from the learner, after a video call is ended. The evaluation data with respect to the instructor may include the degree of satisfaction with respect to the guidance of the instructor, the contribution to the learning, etc. The learning management server 200 may determine how concentrated the learner is on learning, how much the learner understands, etc. by using data generated by capturing an image during a video call with the instructor. This data may be used for selecting the instructor for the learner. When the learning management server 200 transmits the signal for requesting the guidance data to an instructor standing by, instead of an instructor in charge, the learning management server 200 may select the instructor, based on the evaluation data generated by the corresponding learner, the degree of concentration and understanding of the learner, etc.

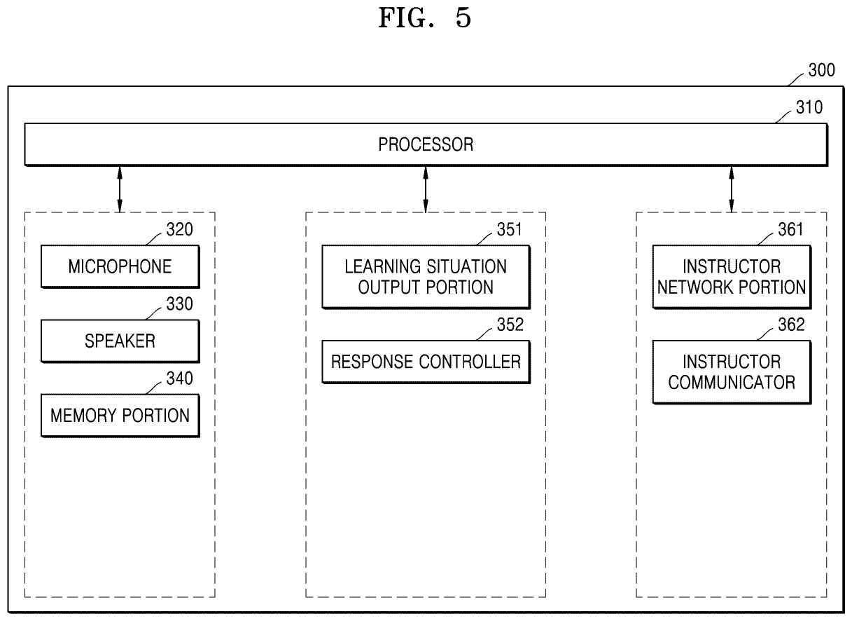

FIG. 5 is a block diagram of the instructor terminal device 300 according to embodiments of the present disclosure.

The instructor terminal device 300 may include a processor 310, a microphone 320, a speaker 330, a memory portion 340, a learning situation output portion 351, a response controller 352, an instructor network portion 361, and an instructor communicator 362.

The processor 310 may control general operations of the instructor terminal device 300 in general. For example, the processor 310 may generally control the components included in the learning management server 200 by executing a program stored in the instructor terminal device 300, the learning situation output portion 351, the response controller 352, the instructor network portion 361, the instructor communicator 362, etc.

The processor 310 may be realized as a DSP configured to process a digital signal, a microprocessor, or a TCON. However, it is not limited thereto and may include, or may be defined by, one or more from among a CPU, an MCU, an MPU, a controller, an AP, a CP, and an ARM processor. Also, the processor 110 may be realized as an SoC, LSI, or an FPGA, in which processing algorithms are embedded.

The microphone 320 may receive a voice input of an instructor.

The speaker 330 may output received audible data.

The memory portion 340 may store data required to perform an operation by at least one of the learning situation output portion 351, the response controller 352, the instructor network portion 361, and the instructor communicator 362.

The learning situation output portion 351 may display a learning paper image received through a camera of a learning guidance device of a learner and information about the learner.

The response controller 352 may control response data including inputs of text, sound, an image, etc. which are input to be generated and may control the response data to be transmitted to the connected learning guidance device or learning management server. The response controller 352 may generate and provide an interface through which text, sound, an image, etc. are input.

The instructor network portion 361 may be in charge of data transmission and reception to and from the learning management server 200.

The instructor communicator 362 may transmit and receive data by communicating with one learning guidance device. The instructor communicator 362 may perform peer to peer (P2P) connection and activate a WebRTC-based voice call.

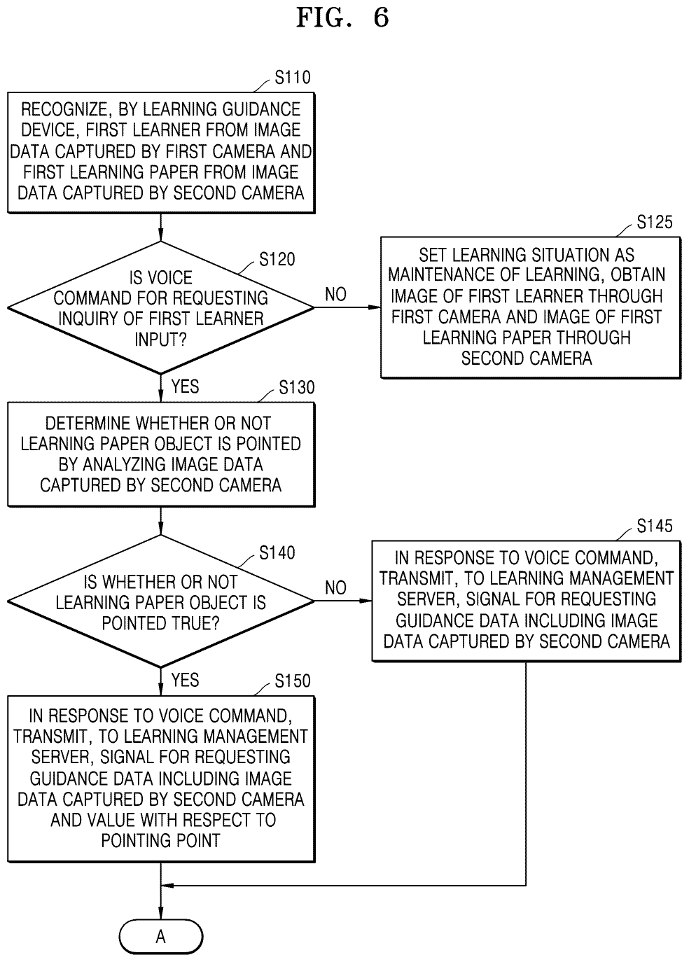

FIG. 6 is a flowchart of a learning guidance method according to embodiments of the present disclosure.

In operation S110, the learning guidance device 100 may recognize a first learner from image data captured by a first camera and may recognize a first learning paper from image data captured by a second camera. The learning guidance device 100 may determine whether or not a learner appears as true and whether or not a learning paper is open as true.

When the learning guidance device 100 recognizes the first learner from the image data captured by the first camera, the learning guidance device 100 may operate a certain timer and stand by until whether or not the learning paper is open becomes true and may end the timer when the stand-by time is equal to or greater than a certain maximum by value. In this case, the learning guidance device 100 may consider that there is no learning

In operation S120, the learning guidance device 100 may detect, through the cameras, whether or not a voice command of the first learner for requesting an inquiry is input. The voice command for requesting the inquiry may be predefined as instructions, such as “I have a question,” “I am not sure about this,” etc.

In operation S125, when the voice command is not input, the learning guidance device may maintain a learning situation as maintenance of learning and may obtain a captured image of the first learner through the first camera and a captured image of a second learner through the second camera.

In operation S130, when the voice command of the first learner for requesting the inquiry is input, the learning guidance device 100 may analyze the image data captured by the second camera and may determine whether or not a learning paper object is pointed. When it is detected through a hand area and a writing instrument area that a hand and a writing instrument are in contact with each other, the learning guidance device 100 may extract a coordinate of the hand and the writing instrument in contact with each other as an area pointed by the learner. When it is detected that the hand and the writing instrument are not in contact with each other, the learning guidance device 100 may detect a coordinate of an end point of an index finger as an area indicated by the learner.

In operation S140, the learning guidance device 100 may detect whether or not the learning paper object is pointed is true, by analyzing the image data captured by the second camera.

In operation S150, when whether or not the learning paper object is pointed is true, the learning guidance device 100 may transmit, to the learning management server, a signal for requesting guidance data including image data captured by the second camera in response to a voice command and the voice command and value with respect to a pointing point.

In operation S145, when whether or not the learning paper object is pointed is false, the learning guidance device 100 may transmit, to the learning management server 200, a signal for requesting guidance data including image data captured by the second camera in response to a voice command and the voice command.

The learning guidance device 100 may generate and provide the guidance data with respect to an inquiry item requested by a student. For example, when a pointing point of the student is “inquiry item 5,” the guidance data may be generated, for example, by audibly providing explanation data with respect to the inquiry item 5. When the pointing point is not clear, the learning guidance device 100 may output audible data for requesting the student to point the pointing point again. When the pointing point does not become clear after a first re-request, the request including the guidance data may be processed by being transmitted to the learning management server 200. In response to the request including the guidance data, guidance may be executed through a video call with an instructor.

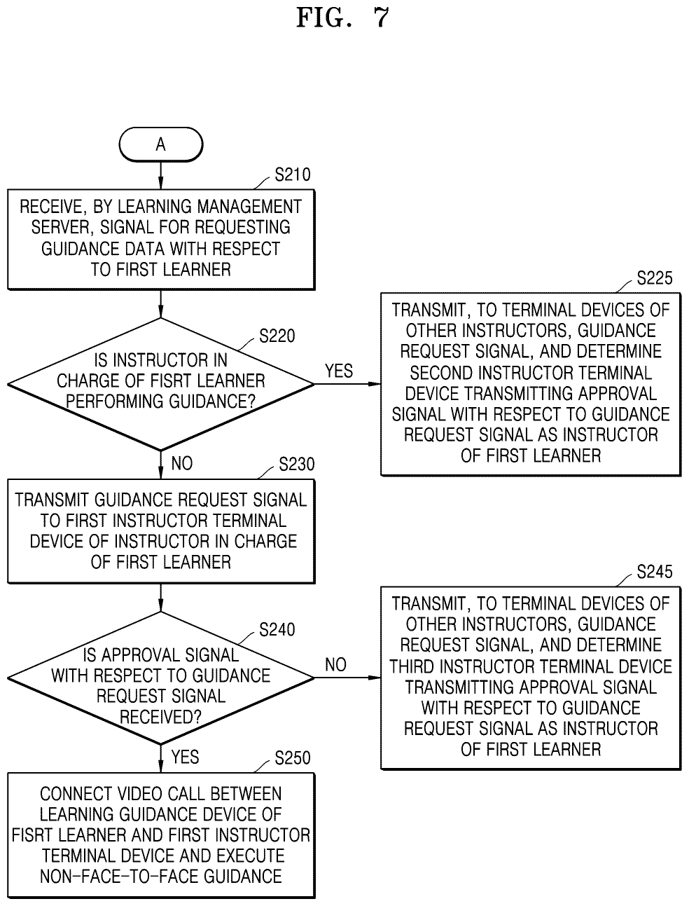

FIG. 7 is a flowchart of a process of processing guidance data, according to embodiments of the present disclosure.

In operation S210, the learning management server 200 may receive, from a learning guidance device, a signal for requesting guidance data with respect to a first learner.

In operation S220, the learning management server 200 may search for an instructor in charge of the first learner and may check whether or not the instructor in charge is performing guidance.

In operation S230, when the instructor in charge is not performing guidance, the learning management server 200 may transmit the guidance request signal to a first instructor terminal device of the instructor in charge of the first learner. When the instructor in charge is performing guidance, the learning management server 200 may transmit the guidance request signal to terminal devices of other instructors and may determine an instructor transmitting an approval signal with respect to the guidance request signal as the instructor of the first learner. The learning management server 200 may determine a terminal device of a second instructor having responded as the instructor of the first learner.

When the approval signal with respect to the guidance request signal is received in operation S240, the learning management server 200 may execute non-face-to-face guidance by connecting a video call between the first instructor terminal device transmitting the approval signal and the learning guidance device of the first learner in operation S250.

In operation S245, when the approval signal with respect to the guidance request is not received from the first instructor terminal device, the learning management server 200 may transmit the guidance request signal to terminal devices of other instructors and may determine a third instructor terminal device transmitting an approval signal with respect to the guidance request signal as the instructor of the first learner.

When the instructor of the first learner is determined, a video call may be connected between the learning guidance device 100 of the first learner and the instructor terminal device 300. The learning situation of the learning guidance device 100 may be changed as learning coaching.

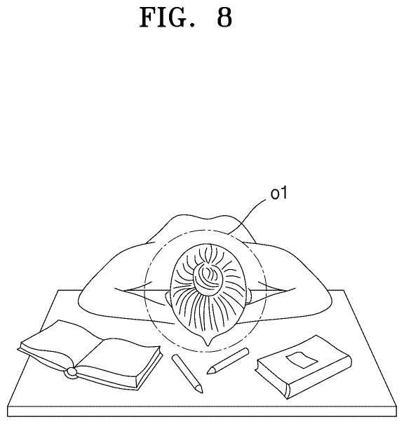

FIG. 8 is an example view of a situation in which whether or not a learner appears is false.

As illustrated in the drawing, when eyes of the learner are not detected in data generated by capturing an image of a learner o1, the learning guidance device 100 may determine whether the number of times the eyes of the learner are not detected exceeds a predefined number while using a certain timer. In a situation in which the number of times the eyes of the learner are not detected exceeds the predefined number, the learning guidance device 100 may determine that the learner is not in state of continued learning, and may output a warning message to the learner. The warning message may be output by being transmitted to another terminal of the learner or a terminal device of a protector of the learner. When the learner is detected after a certain time period has passed after the warning message is output, the situation may be changed to continued learning, and when it is not, the situation may be changed to finished learning.

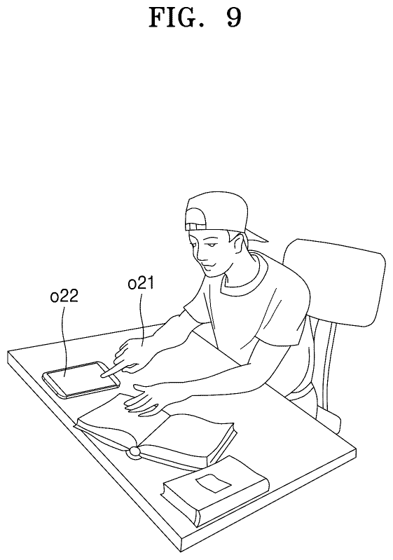

FIG. 9 is an example view of a situation in which whether or not a learning object interruption element is recognized is true.

When, while learning is being continued, the learning guidance device 100 detects that a hand o21 of the learner is in contact with an area o22 except for a learning paper, whether or not the learning object interruption element is recognized may be set as true. The learning guidance device 100 may analyze data generated by capturing an image of the learning paper and may determine whether or not the learning object interruption element is recognized.

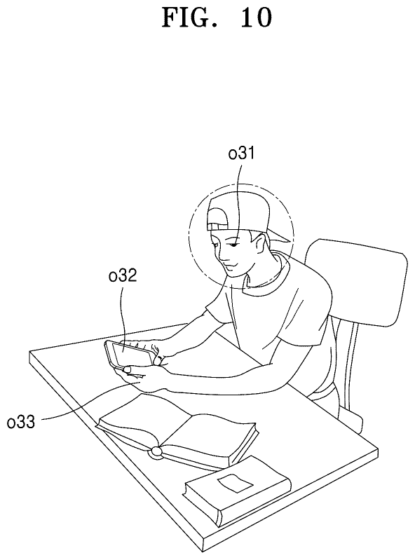

FIG. 10 is an example view of another situation in which whether or not the learning object interruption element is recognized is true.

The learning guidance device 100 may analyze data generated by capturing an image of the learner and may determine whether or not the learning object interruption element is recognized. When a hand area o33 of the learner is in contact with another object o32 except for a learning paper or when there is a change o31 of expression of the learner, whether or not the learning object interruption element is recognized may be set as true.

The device described above may be realized as a hardware component, a software component, and/or a combination of a hardware component and a software component. For example, the devices and the components described according to embodiments may be realized by using one or more general-purpose computers or specific-purpose computers, such as processors, controllers, arithmetic logic units (ALUs), digital signal processors, micro-computers, field programmable gate arrays (FPGAs), programmable logic units (PLUS), microprocessors, or any other devices capable of executing and responding to instructions. The processing device may perform an operating system (OS) and one or more software applications performed on the OS. Also, the processing device may access, store, manipulate, process, and generate data in response to the software execution. For convenience of understanding, there is a case in which it is described that one processing device is used. However, it may be understood by one of ordinary skill in the art that the processing device may include a plurality of processing elements and/or a plurality types of processing elements. For example, the processing device may include a plurality of processors, or one processor and one controller. Also, other processing configurations, such as a parallel processor, may also be possible.

Software may include a computer program, a code, an instruction, or a combination of at least two thereof, and may configure a processing device or independently or collectively instruct the processing device to operate as desired. Software and/or data may be permanently or temporarily embodied in a certain type of machine, component, physical device, virtual equipment, computer storage medium or device, or transmitted signal wave, to be interpreted by a processing device or to provide a command or data to the processing device. Software may be distributed on a computer system connected by a network and may be stored or executed in a distributed fashion. Software and data may be stored in one or more computer-readable recording devices.

The method according to an embodiment may be implemented in the form of a program command executable by various computer devices and may be recorded on a computer-readable medium. The computer-readable medium may separately include each of a program command, a data file, a data structure, etc. or may include a combination thereof. The program command recorded on the medium may be specially designed and configured for an embodiment or may be well known to and usable by one of ordinary skill in the art. Examples of the computer-readable recording medium include magnetic media (e.g., hard discs, floppy discs, or magnetic tapes), optical media (e.g., compact disc-read only memories (CD-ROMs), or digital versatile discs (DVDs)), magneto-optical media (e.g., floptical discs), and hardware devices that are specially configured to store and carry out program commands (e.g., ROMs, random-access memories (RAMs), or flash memories). Examples of the program commands include a high-level language code executable by a computer by using an interpreter, etc., as well as a machine language code, such as the one made by a complier. The hardware device may be configured to operate via one or more software modules to perform the operations according to embodiments, or one or more software modules may be configured to operate the hardware device to perform the operations according to embodiments.

As above, embodiments are described based on the limited embodiments and drawings. However, based on the descriptions, various modifications and alterations are possible for one of ordinary skill in the art. For example, appropriate results may be achieved even when the described techniques are performed in a different order from the described method, and/or the described components, such as the system, structure, device, circuit, etc., are coupled or combined in a different form from the described method or replaced or substituted by other components or equivalents.

Therefore, other realized examples, other embodiments, and equivalents to the claims are also included in the scope of the claims set forth below.

1. A method of remotely monitoring a learner's learning situation, the method comprising: by a learning guidance device, obtaining first image data generated by capturing an image of a learner through a first camera, and obtaining second image data generated by capturing an image of a learning paper through a second camera;
obtaining, by the learning guidance device, a voice command of the learner through the first or second camera;
transmitting, by the learning guidance device, a signal for requesting guidance data comprising the first or second image data, corresponding to the voice command of the learner, to a learning management server; and
outputting, by the learning guidance device, the guidance data received from the learning management server.

2. The method of claim 1, further comprising determining, by the learning guidance device, whether or not the learner appears and whether or not the learning paper is open, by analyzing the first or second image data by using one or more situation recognition models, and when whether or not the learner appears is true and whether or not the learning paper is open is true, setting, by the learning guidance device, a learning situation as “performing learning.”

3. The method of claim 1, further comprising detecting, by the learning guidance device, a hand area and a writing instrument area from the second image data, and, based on whether or not the hand area and the writing instrument area are in contact with each other, setting, by the learning guidance device, a learning situation as “maintenance of learning.”

4. The method of claim 1, further comprising calculating, by the learning guidance device, a finger end point or a writing instrument end point from the second image data, and setting, by the learning guidance device, the finger end point or the writing instrument end point as a pointing point.

5. The method of claim 1, further comprising connecting, by the learning management server, a video call between the learning guidance device and an instructor terminal device of an instructor in charge of the learner.

6. A learning guidance device comprising a first camera, a second camera, a processor, and a client network portion, wherein the first camera obtains first image data by capturing an image of a learner,
the second camera obtains second image data by capturing an image of a learning paper, and
the processor analyzes the first or second image data to recognize a voice command of the learner, transmits a signal for requesting guidance data comprising the first or second image data, corresponding to the voice command of the learner, to a learning management server, and outputs the guidance data received from the learning management server.

7. The learning guidance device of claim 6, wherein the processor determines whether or not the learner appears and whether or not the learning paper is open by analyzing the first or second image data by using one or more situation recognition models, and sets a learning situation as “performing learning” when whether or not the learner appears is true and whether or not the learning paper is open is true.

8. The learning guidance device of claim 6, wherein the processor detects a hand area and a writing instrument area from the second image data and, based on whether or not the hand area and the writing instrument area are in contact with each other, sets a learning situation as “maintenance of learning.”

9. The learning guidance device of claim 6, wherein the processor calculates a finger end point or a writing instrument end point from the second image data and sets the finger end point or the writing instrument end point as a pointing point.

10. The learning guidance device of claim 6, wherein the processor connects a video call between the learning guidance device and an instructor terminal device of an instructor in charge of the learner.

11. A computer program stored on a computer-readable storage medium for executing, by using a computer, the method of claim 1.
